(19) United States
(12) Patent Application Publication
(10) Pub. No.: US 2026/0311493 A1
(43) Pub. Date: Oct. 8, 2026

(54) OTHER VEHICLE BEHAVIOR PREDICTION DEVICE, OTHER VEHICLE BEHAVIOR PREDICTION METHOD, AND NON-TRANSITORY RECORDING MEDIUM

(71) Applicant: TOYOTA JIDOSHA KABUSHIKI KAISHA, Toyota-shi (JP)

(72) Inventor: Masaaki YAMAOKA, Tokyo-to (JP)

(73) Assignee: TOYOTA JIDOSHA KABUSHIKI KAISHA, Toyota-shi (JP)

(21) Appl. No.: 19/634,853

(22) Filed: Mar. 31, 2026

(30) Foreign Application Priority Data
Apr. 2, 2025 (JP) 2025-061341

(51) Int. Cl. G06V 20/58; G08G 1/16

(52) U.S. Cl. CPC G06V 20/58; G08G 1/166; G08G 1/167; G06V 2201/08

(57) ABSTRACT

An other vehicle behavior prediction device predicts behavior of an other vehicle travelling in surroundings of a host vehicle, and acquires information representing whether a surrounding situation sensor for detecting a surrounding situation of the other vehicle is included in the other vehicle or information representing a configuration of the surrounding situation sensor included in the other vehicle, behavior of the other vehicle is predicted based on information representing whether the surrounding situation sensor is included in the other vehicle or information representing a configuration of the surrounding situation sensor included in the other vehicle.

### FIELD

The present disclosure relates to an other vehicle behavior prediction device, an other vehicle behavior prediction method, and a non-transitory recording medium.

### BACKGROUND

Patent Literature 1 (Japanese Unexamined Patent Publication (Kokai) No. 2018-180641) describes acquiring the behavior of a target vehicle and estimating the behavior of the target vehicle.

Though the behavior of an other vehicle has been predicted (estimated) in the past, the behavior of the other vehicle has been predicted without considering whether a surrounding situation sensor is included in the other vehicle or the configuration of the surrounding situation sensor included in the other vehicle. When a surrounding vehicle traveling in the surroundings of the other vehicle is detected by a surrounding situation sensor included in the other vehicle, the other vehicle often changes lanes, accelerates, or decelerates to avoid contact with or approaching the surrounding vehicle, whereas when the other vehicle is unaware of the surrounding vehicle traveling in the surroundings thereof, it is thought that the other vehicle rarely changes lanes, accelerates, or decelerates to avoid contact with or approaching the surrounding vehicle. Conventionally, the behavior of the other vehicle has been predicted without considering whether a surrounding situation sensor is included in the other vehicle or the configuration of the surrounding situation sensor included in the other vehicle, whereby the behavior of the other vehicle cannot be predicted with high accuracy.

### SUMMARY

In view of the foregoing, an object of the present disclosure is to provide an other vehicle behavior prediction device, an other vehicle behavior prediction method, and a non-transitory recording medium with which the behavior of an other vehicle can be predicted with high accuracy.
(1) An aspect of the present disclosure provides an other vehicle behavior prediction device including a processor configured to: predict behavior of an other vehicle travelling in surroundings of a host vehicle; and acquire information representing whether a surrounding situation sensor for detecting a surrounding situation of the other vehicle is included in the other vehicle or information representing a configuration of the surrounding situation sensor included in the other vehicle, wherein the processor is configured to predict behavior of the other vehicle based on information representing whether the surrounding situation sensor is included in the other vehicle or information representing a configuration of the surrounding situation sensor included in the other vehicle.
(2) In the other vehicle behavior prediction device of Aspect (1), behavior of the other vehicle predicted when information representing that the surrounding situation sensor is not included in the other vehicle is acquired and behavior of the other vehicle predicted when information representing that the surrounding situation sensor is included in the other vehicle is acquired may be different.
(3) In the other vehicle behavior prediction device of Aspect (1) or (2), the processor may be configured to: acquire information representing whether a surrounding vehicle traveling in surroundings of the other vehicle is present; and predict a possibility of a lane change of the other vehicle based on information representing whether the surrounding situation sensor is included in the other vehicle or information representing a configuration of the surrounding situation sensor included in the other vehicle, and information representing whether the surrounding vehicle is present, by using a prediction model obtained by performing learning using teacher data, which is a data set of information representing whether a learning surrounding situation sensor for detecting a surrounding situation of a learning other vehicle is included in the learning other vehicle or information representing a configuration of the learning surrounding situation sensor included in the learning other vehicle and information representing whether a learning surrounding vehicle traveling in surroundings of the learning other vehicle is present, and labels representing information on whether the learning other vehicle changed lanes.
(4) In the other vehicle behavior prediction device according to any of Aspects (1) to (3), the processor may be configured to: generate information representing whether the surrounding situation sensor is included in the other vehicle or information representing a configuration of the surrounding situation sensor included in the other vehicle based on an image including the other vehicle captured by a camera mounted on the host vehicle; and acquire information representing whether the surrounding situation sensor is included in the other vehicle or information representing a configuration of the surrounding situation sensor included in the other vehicle.
(5) In the other vehicle behavior prediction device according to any of Aspects (1) to (4), the processor may be configured to acquire information representing whether the surrounding situation sensor is included in the other vehicle or information representing a configuration of the surrounding situation sensor included in the other vehicle obtained by communication between the host vehicle and outside of the host vehicle.
(6) In the other vehicle behavior prediction device of any of Aspects (1) to (5), the processor may be configured to: generate information representing whether the surrounding situation sensor is included in the other vehicle or information representing a configuration of the surrounding situation sensor included in the other vehicle based on radio waves which are transmitted from the surrounding situation sensor and detected by a radar detector mounted on the host vehicle; and acquire information representing whether the surrounding situation sensor is included in the other vehicle or information representing a configuration of the surrounding situation sensor included in the other vehicle.
(7) An aspect of the present disclosure provides an other vehicle behavior prediction method including: predicting behavior of an other vehicle travelling in surroundings of a host vehicle; and acquiring information representing whether a surrounding situation sensor for detecting a surrounding situation of the other vehicle is included in the other vehicle or information representing a configuration of the surrounding situation sensor included in the other vehicle, wherein behavior of the other vehicle is predicted based on information representing whether the surrounding situation sensor is included in the other vehicle or information representing a configuration of the surrounding situation sensor included in the other vehicle.
(8) An aspect of the present disclosure provides a non-transitory recording medium having recorded thereon a computer program for causing a processor to perform a process including: predicting behavior of an other vehicle travelling in surroundings of a host vehicle; and acquiring information representing whether a surrounding situation sensor for detecting a surrounding situation of the other vehicle is included in the other vehicle or information representing a configuration of the surrounding situation sensor included in the other vehicle, wherein behavior of the other vehicle is predicted based on information representing whether the surrounding situation sensor is included in the other vehicle or information representing a configuration of the surrounding situation sensor included in the other vehicle.

According to the present disclosure, the behavior of an other vehicle can be predicted with high accuracy.

### BRIEF DESCRIPTION OF DRAWINGS

FIG. 1 is a view showing an example of a host vehicle 1 to which an other vehicle behavior prediction device 15 of a first embodiment is applied.

FIG. 2A is a view showing an example of prediction results, etc., of behavior of an other vehicle OV by an other vehicle behavior prediction unit 3F when a surrounding situation sensor for detecting a surrounding situation (surrounding vehicle SV) of the other vehicle OV is not included in the other vehicle OV.

FIG. 2B is a view showing an example of prediction results, etc., of behavior of the other vehicle OV by the other vehicle behavior prediction unit 3F when a surrounding situation sensor for detecting a surrounding situation (surrounding vehicle SV) of the other vehicle OV is included in the other vehicle OV.

FIG. 3 is a flowchart for explaining an example of a process performed by a processor 153 of the other vehicle behavior prediction device 15 of the first embodiment.

FIG. 4A is a view showing an example of prediction results, etc., of behavior of the other vehicle OV by the other vehicle behavior prediction unit 3F when a surrounding situation sensor for detecting a surrounding situation (surrounding vehicle SV) of the other vehicle OV is not included in the other vehicle OV.

FIG. 4B is a view showing an example of prediction results, etc., of behavior of the other vehicle OV by the other vehicle behavior prediction unit 3F when a surrounding situation sensor for detecting a surrounding situation (surrounding vehicle SV) of the other vehicle OV is included in the other vehicle OV.

### DESCRIPTION OF EMBODIMENTS

The embodiments of the other vehicle behavior prediction device, the other vehicle behavior prediction method, and the non-transitory recording medium of the present disclosure will be described below with reference to the drawings.

### First Embodiment

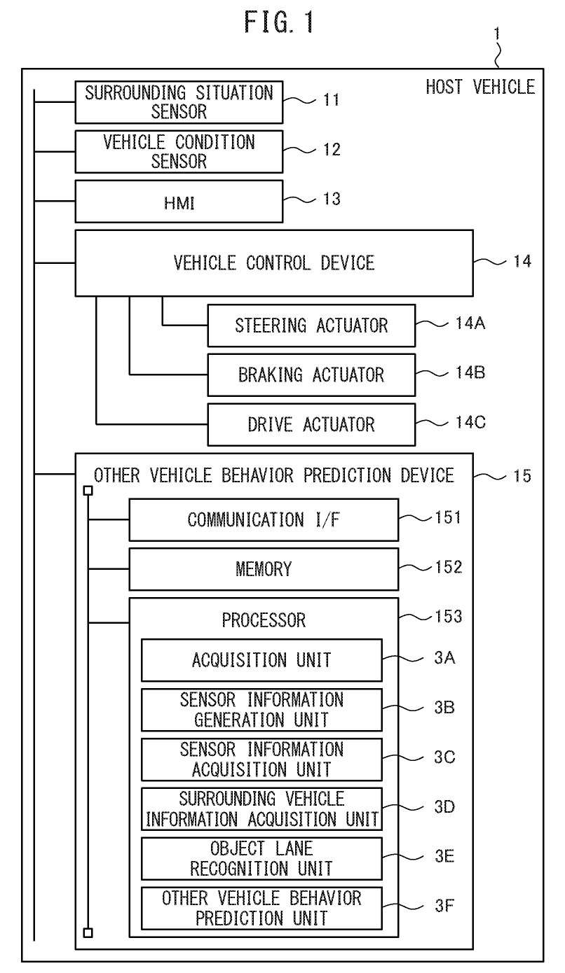

FIG. 1 is a view showing an example of a host vehicle 1 to which an other vehicle behavior prediction device 15 of a first embodiment is applied.

In the example shown in FIG. 1, the host vehicle 1 includes a surrounding situation sensor 11, a vehicle condition sensor 12, an HMI (Human Machine Interface) 13, a vehicle control device 14, a steering actuator 14A, a braking actuator 14B, a drive actuator 14C, and the other vehicle behavior prediction device 15.

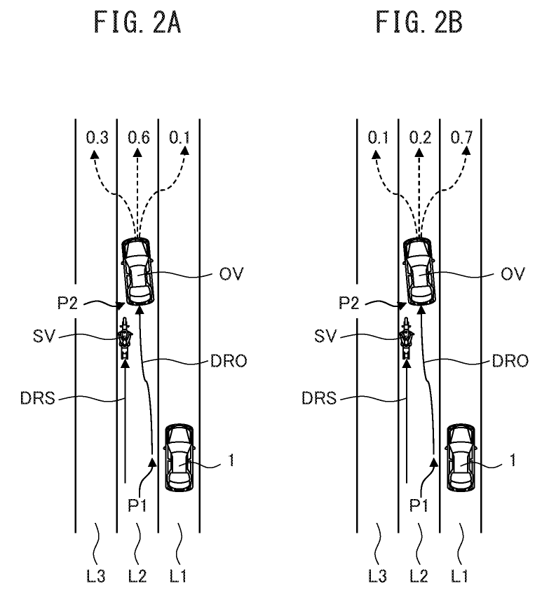

The surrounding situation sensor 11 detects the surrounding situation of the host vehicle 1 (for example, other vehicle OV (refer to FIG. 2A and FIG. 2B) traveling in the surroundings of the host vehicle 1, surrounding vehicle SV (refer to FIG. 2A and FIG. 2B) traveling in the surroundings of the other vehicle OV, obstacles positioned in the surroundings of the host vehicle 1, etc.), and transmits the detection results of the surrounding situation of the host vehicle 1 to the vehicle control device 14 and the other vehicle behavior prediction device 15. The surrounding situation sensor 11 includes, for example, a camera, a LiDAR (Light Detection And Ranging), a Radar, a wireless communication device for acquiring information representing the situation outside the host vehicle 1 from outside the host vehicle 1 via wireless communication, a radar detector for detecting radio waves transmitted (emitted) from radar (not illustrated) mounted on the other vehicle OV, etc.

The vehicle condition sensor 12 detects the condition of the host vehicle 1, measures the position of the host vehicle 1, and transmits the detection results of the condition of the host vehicle 1 and the measurement results of the position of the host vehicle 1 to the vehicle control device 14 and the other vehicle behavior prediction device 15. The vehicle condition sensor 12 includes, for example, a vehicle speed sensor, an acceleration sensor, a yaw rate sensor, a gyro sensor, a GPS (Global Positioning System) receiver, etc.

The HMI 13 has functions such as accepting various operations by the driver of the host vehicle 1, and transmits signals representing the operations by the driver of the host vehicle 1 to the vehicle control device 14.

The vehicle control device 14 controls the steering actuator 14A, the braking actuator 14B, and the drive actuator 14C based on, for example, information (data, signals) transmitted from the surrounding situation sensor 11, the vehicle condition sensor 12, and the HMI 13. In detail, the vehicle control device 14 has an autonomous driving function for controlling the steering actuator 14A, the braking actuator 14B, and the drive actuator 14C to cause the host vehicle 1 to drive autonomously without the need for operation by the driver of the host vehicle 1. Specifically, the vehicle control device 14 generates a driving plan for the host vehicle 1 to reach its destination based on, for example, map information, position information of the host vehicle 1, information representing the destination of the host vehicle 1, etc. Furthermore, the vehicle control device 14 causes the host vehicle 1 to drive autonomously in accordance with the driving plan. In detail, the vehicle control device 14 causes the host vehicle 1 to drive autonomously while revising the driving plan to avoid collisions between the host vehicle 1 and the other vehicles OV (refer to FIG. 2A and FIG. 2B), etc., based on the detection results of the surrounding situation sensor 11, prediction results of the behavior of the other vehicles OV by the other vehicle behavior prediction device 15, which will be described later, etc.

The other vehicle behavior prediction device 15 is constituted by a microcomputer including a communication interface (I/F) 151, a memory 152, and a processor 153.

The communication interface 151 includes an interface circuit for connecting the other vehicle behavior prediction device 15 to the surrounding situation sensor 11, the vehicle condition sensor 12, the HMI 13, and the vehicle control device 14. The memory 152 stores a program used in a process performed by the processor 153 and various data. The processor 153 has a function as an acquisition unit 3A, a function as a sensor information generation unit 3B, a function as a sensor information acquisition unit 3C, a function as a surrounding vehicle information acquisition unit 3D, a function as an object lane recognition unit 3E, and a function as an other vehicle behavior prediction unit 3F.

In the example shown in FIG. 1, the acquisition unit 3A acquires detection results of the surrounding situation of the host vehicle 1 by the surrounding situation sensor 11, etc.

Specifically, the acquisition unit 3A acquires, as the detection results of the surrounding situation of the host vehicle 1 by the surrounding situation sensor 11, for example, an image including the other vehicle OV (refer to FIG. 2A and FIG. 2B) captured by a camera serving as the surrounding situation sensor 11, the detection results of the surrounding situation of the host vehicle 1 by the LiDAR serving as the surrounding situation sensor 11, the detection results of the surrounding situation of the host vehicle 1 by the radar serving as the surrounding situation sensor 11, the results of communication between the host vehicle 1 and the outside of the host vehicle 1 by the wireless communication device serving as the surrounding situation sensor 11, and information representing radio waves which are transmitted (emitted) from radar (surrounding situation sensor) (not illustrated) mounted on the other vehicle OV and detected by the radar detector serving as the surrounding situation sensor 11.

In the example shown in FIG. 1, the sensor information generation unit 3B generates information representing whether a surrounding situation sensor for detecting the surrounding situation of the other vehicle OV is included in the other vehicle OV, or information representing the configuration of the surrounding situation sensor included in the other vehicle OV, based on the detection results of the surrounding situation of the host vehicle 1 by the surrounding situation sensor 11 acquired by the acquisition unit 3A.

Specifically, in an example in which the acquisition unit 3A acquires an image including the other vehicle OV, etc., captured by the camera serving as the surrounding situation sensor 11, the sensor information generation unit 3B generates information representing whether a surrounding situation sensor for detecting the surrounding situation of the other vehicle OV is included in the other vehicle OV, or information representing the configuration of the surrounding situation sensor included in the other vehicle OV, based on the image including the other vehicle OV, etc., captured by the camera serving as the surrounding situation sensor 11.

Furthermore, in an example in which the acquisition unit 3A acquires information representing radio waves which are transmitted (emitted) from a radar mounted on the other vehicle OV and detected by a radar detector serving as the surrounding situation sensor 11, the sensor information generation unit 3B generates information representing whether a surrounding situation sensor (radar) for detecting the surrounding situation of the other vehicle OV is included in the other vehicle OV, or information representing the configuration of the surrounding situation sensor (radar) included in the other vehicle OV, based on the radio waves which are transmitted from the radar mounted on the other vehicle OV and detected by the radar detector serving as the surrounding situation sensor 11.

Furthermore, in the example shown in FIG. 1, the sensor information acquisition unit 3C acquires information representing whether a surrounding situation sensor for detecting the surrounding situation of the other vehicle OV is included in the other vehicle OV, or information representing the configuration of the surrounding situation sensor included in the other vehicle OV.

Specifically, in an example in which the sensor information generation unit 3B generates information representing whether a surrounding situation sensor for detecting the surrounding situation of the other vehicle OV is included in the other vehicle OV, or information representing the configuration of the surrounding situation sensor included in the other vehicle OV, the sensor information acquisition unit 3C acquires information representing whether a surrounding situation sensor for detecting the surrounding situation of the other vehicle OV is included in the other vehicle OV or information representing the configuration of the surrounding situation sensor included in the other vehicle OV generated by the sensor information generation unit 3B.

Furthermore, in an example in which the sensor information generation unit 3B does not generate information representing whether a surrounding situation sensor for detecting the surrounding situation of the other vehicle OV is included in the other vehicle OV or information representing the configuration of the surrounding situation sensor included in the other vehicle OV, the sensor information acquisition unit 3C acquires information representing whether a surrounding situation sensor for detecting the surrounding situation of the other vehicle OV is included in the other vehicle OV or information representing the configuration of the surrounding situation sensor included in the other vehicle OV obtained from the detection results of the surrounding situation of the host vehicle 1 by the surrounding situation sensor 11 acquired by the acquisition unit 3A. Specifically, the sensor information acquisition unit 3C acquires, for example, information representing whether a surrounding situation sensor for detecting the surrounding situation of the other vehicle OV is included in the other vehicle OV, or information representing the configuration of the surrounding situation sensor included in the other vehicle OV obtained as the detection results of the surrounding situation of the host vehicle 1 via communication between the host vehicle 1 and the outside of the host vehicle 1 performed by the wireless communication device serving as the surrounding situation sensor 11.

Furthermore, in the example shown in FIG. 1, the surrounding vehicle information acquisition unit 3D acquires information representing whether a surrounding vehicle SV (refer to FIG. 2A and FIG. 2B) traveling in the surroundings of the other vehicle OV (refer to FIG. 2A and FIG. 2B) is present obtained from the detection results (for example, camera image, LiDAR detection results, communication results of the wireless communication device, etc.) of the surrounding situation of the host vehicle 1 by the surrounding situation sensor 11 acquired by the acquisition unit 3A.

The object lane recognition unit 3E performs recognition of objects such as the other vehicle OV (refer to FIG. 2A and FIG. 2B) traveling in the surroundings of the host vehicle 1 and the surrounding vehicle SV (refer to FIG. 2A and FIG. 2B) traveling in the surroundings of the other vehicles OV, and recognition of lanes positioned in the surroundings of the host vehicle 1, based on the detection results of the surrounding situation of the host vehicle 1 acquired by the acquisition unit 3A.

The other vehicle behavior prediction unit 3F predicts the behavior of the other vehicle OV based on information representing whether a surrounding situation sensor for detecting the surrounding situation of the other vehicle OV is included in the other vehicle OV, or information representing the configuration of the surrounding situation sensor included in the other vehicle OV acquired by the sensor information acquisition unit 3C.

FIG. 2A and FIG. 2B are views showing examples of time series detection results DRO of the other vehicle OV by the surrounding situation sensor 11, time series detection results DRS of the surrounding vehicle SV by the surrounding situation sensor 11, and prediction results of the behavior of the other vehicle OV by the other vehicle behavior prediction unit 3F. In detail, FIG. 2A shows an example of prediction results of the behavior of the other vehicle OV by the other vehicle behavior prediction unit 3F when a surrounding situation sensor for detecting the surrounding situation (surrounding vehicle SV) of the other vehicle OV is not included in the other vehicle OV, and FIG. 2B shows an example of prediction results of the behavior of the other vehicle OV by the other vehicle behavior prediction unit 3F when a surrounding situation sensor for detecting the surrounding situation (surrounding vehicle SV) of the other vehicle OV is included in the other vehicle OV.

In the example shown in FIG. 2A, the host vehicle 1 is traveling in the lane L1, the other vehicle OV is traveling in the lane L2, and the surrounding vehicle SV is passing on the left side (the left side of FIG. 2A) of the other vehicle OV and attempting to overtake the other vehicle OV. Specifically, the other vehicle OV is passing through the position P2 of the lane L2. The other vehicle behavior prediction device 15 predicts the behavior of the other vehicle OV from the time point shown in FIG. 2A onwards to enable the host vehicle 1 to travel safely without a collision between the host vehicle 1 and the other vehicle OV.

Specifically, in the example shown in FIG. 2A, the sensor information acquisition unit 3C acquires information representing that a surrounding situation sensor for detecting the surrounding situation of the other vehicle OV (more specifically, a surrounding situation sensor (for example, a rear radar, a rear camera, etc.) which can detect the surrounding vehicle SV) is not included in the other vehicle OV.

The other vehicle behavior prediction unit 3F predicts behavior of the other vehicle OV based on information representing that a surrounding situation sensor (more specifically, a surrounding situation sensor which can detect the surrounding vehicle SV) for detecting the surrounding situation of the other vehicle OV is not included in the other vehicle OV acquired by the sensor information acquisition unit 3C, time series detection results DRO of the other vehicle OV by the surrounding situation sensor 11 (and more specifically, the trajectory of the position of the other vehicle OV from the time the other vehicle OV passes the position P1 to the time the other vehicle OV passes the position P2), and time series detection results DRS of the surrounding vehicle SV by the surrounding situation sensor 11.

In detail, the other vehicle behavior prediction unit 3F predicts that the possibility of the other vehicle OV changing lanes from the lane L2 to the lane L3 is 30%, predicts that the possibility of the other vehicle OV continuing to travel in the lane L2 without changing lanes is 60%, and predicts that the possibility of the other vehicle OV changing lanes from the lane L2 to the lane L1 is 10%.

In the example shown in FIG. 2B, the host vehicle 1 is traveling in the lane L1, the other vehicle OV is traveling in the lane L2, and the surrounding vehicle SV is passing on the left side (the left side of FIG. 2B) of the other vehicle OV and attempting to overtake the other vehicle OV. More specifically, the other vehicle OV is passing through the position P2 of lane the L2. The other vehicle behavior prediction device 15 predicts the behavior of the other vehicle OV from the time point shown in FIG. 2B onwards to enable the host vehicle 1 to travel safely without a collision between the host vehicle 1 and the other vehicle OV.

Specifically, in the example shown in FIG. 2B, the sensor information acquisition unit 3C acquires information representing that a surrounding situation sensor for detecting the surrounding situation of the other vehicle OV (more specifically, a surrounding situation sensor (for example, a rear radar, a rear camera, etc.) which can detect the surrounding vehicle SV) is included in the other vehicle OV.

The other vehicle behavior prediction unit 3F predicts the behavior of the other vehicle OV based on information representing that a surrounding situation sensor (more specifically, a surrounding situation sensor which can detect the surrounding vehicle SV ) for detecting the surrounding situation of the other vehicle OV is included in the other vehicle OV acquired by the sensor information acquisition unit 3C, time series detection results DRO of the other vehicle OV by the surrounding situation sensor 11 (more specifically, the trajectory of the position of the other vehicle OV from the time the other vehicle OV passes the position P1 to the time the other vehicle OV passes the position P2), and time series detection results DRS of the surrounding vehicle SV by the surrounding situation sensor 11.

In detail, the other vehicle behavior prediction unit 3F predicts that the possibility of the other vehicle OV changing lanes from the lane L2 to the lane L3 is 10%, predicts that the possibility of the other vehicle OV continuing to travel in the lane L2 without changing lanes is 20%, and predicts that the possibility of the other vehicle OV changing lanes from the lane L2 to the lane L1 is 70%.

In the example shown in FIG. 2A and FIG. 2B, the behavior of the other vehicle OV (the possibility of the other vehicle OV changing lanes from the lane L2 to the lane L3 is 30%, the possibility of the other vehicle OV continuing to travel in the lane L2 without changing lanes is 60%, and the possibility of the other vehicle OV changing lanes from the lane L2 to the lane L1 is 10%) predicted by the other vehicle behavior prediction unit 3F when information representing that a surrounding situation sensor (more specifically, a surrounding situation sensor which can detect the surrounding vehicle SV) for detecting the surrounding situation of the other vehicle OV is not included in the other vehicle OV is acquired by the sensor information acquisition unit 3C and the behavior of the other vehicle OV (the possibility of the other vehicle OV changing lanes from the lane L2 to the lane L3 is 10%, the possibility of the other vehicle OV continuing to travel in the lane L2 without changing lanes is 20%, and the possibility of the other vehicle OV changing lanes from the lane L2 to the lane L1 is 70%) predicted by the other vehicle behavior prediction unit 3F when information representing that a surrounding situation sensor (more specifically, a surrounding situation sensor which can detect the surrounding vehicle SV) for detecting the surrounding situation of the other vehicle OV is included in the other vehicle OV is acquired by the sensor information acquisition unit 3C are different.

Though the trajectory of the position of the other vehicle OV from the time when the other vehicle OV passes the position P1 to the time when the other vehicle OV passes the position P2 is used as the time series detection result DRO of the other vehicle OV by the surrounding situation sensor 11 in the example shown in FIG. 2A and FIG. 2B, in another example, the detection result of the orientation of the other vehicle OV from the time when the other vehicle OV passes the position P1 to the time when the other vehicle OV passes the position P2 may be used as the time series detection result DRO of the other vehicle OV by the surrounding situation sensor 11.

In yet another example, detection results such as the speed, acceleration, or braking pattern of the other vehicle OV from the time when the other vehicle OV passes the position P1 to the time when the other vehicle OV passes the position P2 may be used as the time series detection results DRO of the other vehicle OV by the surrounding situation sensor 11.

In the example shown in FIG. 1, the other vehicle behavior prediction unit 3F predicts the possibility of a lane change of the other vehicle OV based on information representing whether a surrounding situation sensor (more specifically, a surrounding situation sensor which can detect surrounding vehicle SV) for detecting the surrounding situation of the other vehicle OV is included in the other vehicle OV or information representing the configuration of the surrounding situation sensor for detecting the surrounding situation of the other vehicle OV included in the other vehicle OV acquired by the sensor information acquisition unit 3C, and information representing whether a surrounding vehicle SV is present acquired by the surrounding vehicle information acquisition unit 3D, by using a prediction model obtained by performing learning using teacher data, which is a data set of information representing whether a learning surrounding situation sensor (not illustrated) for detecting the surrounding situation of a learning other vehicle (not illustrated) is included in the learning other vehicle or information representing the configuration of the learning surrounding situation sensor included in the learning other vehicle and information representing whether a learning surrounding vehicle (not illustrated) traveling in surroundings of the learning other vehicle is present, and labels representing information on whether the learning other vehicle changed lanes.

Specifically, in the example shown in FIG. 2A, the other vehicle behavior prediction unit 3F predicts that the possibility that the other vehicle OV will change lanes is 40% and predicts that the possibility that the other vehicle OV will not change lanes is 60%. In the example shown in FIG. 2B, the other vehicle behavior prediction unit 3F predicts that the possibility that the other vehicle OV will change lanes is 80% and predicts that the possibility that the other vehicle OV will not change lanes is 20%.

In another example, the other vehicle behavior prediction unit 3F may use a prediction model obtained by a method different from the example shown in FIG. 1 to predict the possibility that the other vehicle OV will change lanes based on information representing whether a surrounding situation sensor for detecting the surrounding situation of the other vehicle OV is included in the other vehicle OV, or information representing the configuration of the surrounding situation sensor for detecting the surrounding situation of the other vehicle OV included in the other vehicle OV acquired by the sensor information acquisition unit 3C, and information representing whether a surrounding vehicle SV is present acquired by the surrounding vehicle information acquisition unit 3D.

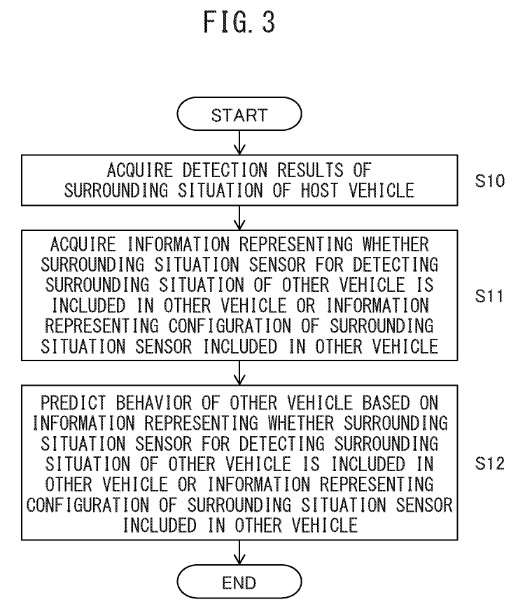

FIG. 3 is a flowchart for explaining an example of a process performed by the processor 153 of the other vehicle behavior prediction device 15 of the first embodiment.

In the example shown in FIG. 3, in step S10, the acquisition unit 3A acquires the detection results of the surrounding situation of the host vehicle 1.

In step S11, the sensor information acquisition unit 3C acquires information representing whether a surrounding situation sensor for detecting the surrounding situation of the other vehicle OV is included in the other vehicle OV, or information representing the configuration of the surrounding situation sensor included in the other vehicle OV.

In step S12, the other vehicle behavior prediction unit 3F predicts behavior of the other vehicle OV based on information representing whether a surrounding situation sensor for detecting the surrounding situation of the other vehicle OV is included in the other vehicle OV, or information representing the configuration of the surrounding situation sensor included in the other vehicle OV acquired in step S11.

The other vehicle behavior prediction device 15 of the first embodiment can predict behavior of the other vehicle OV with higher accuracy than when behavior of the other vehicle OV is predicted without consideration regarding whether a surrounding situation sensor for detecting the surrounding situation of the other vehicle OV is included in the other vehicle OV or regarding the configuration of the surrounding situation sensor included in the other vehicle OV.

### Second Embodiment

The host vehicle 1 to which the other vehicle behavior prediction device 15 of a second embodiment is applied is configured in the same manner as the host vehicle 1 to which the other vehicle behavior prediction device 15 of the first embodiment is applied, except for the points described below.

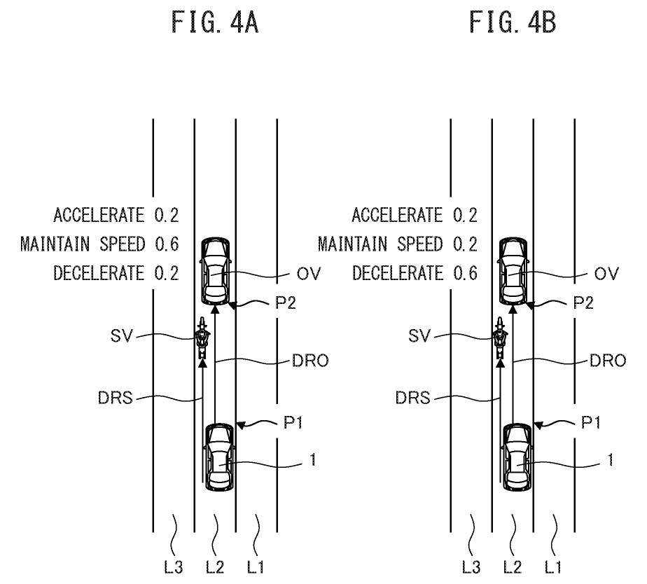

FIG. 4A and FIG. 4B are views showing examples of time series detection results DRO of the other vehicle OV by the surrounding situation sensor 11, time series detection results DRS of the surrounding vehicle SV by the surrounding situation sensor 11, and prediction results of the behavior of the other vehicle OV by the other vehicle behavior prediction unit 3F of the other vehicle behavior prediction device 15 of the second embodiment. In detail, FIG. 4A shows an example of prediction results of the behavior of the other vehicle OV by the other vehicle behavior prediction unit 3F when a surrounding situation sensor for detecting the surrounding situation (surrounding vehicle SV) of the other vehicle OV is not included in the other vehicle OV, and FIG. 4B shows an example of prediction results of the behavior of the other vehicle OV by the other vehicle behavior prediction unit 3F when a surrounding situation sensor for detecting the surrounding situation (surrounding vehicle SV) of the other vehicle OV is included in the other vehicle OV.

In the example shown in FIG. 4A, the host vehicle 1 is traveling in the lane L2, the other vehicle OV is traveling in front of the host vehicle 1, and the surrounding vehicle SV is passing on the left side (the left side of FIG. 4A) of the other vehicle OV and attempting to overtake the other vehicle OV. More specifically, the other vehicle OV is passing through the position P2 of the lane L2. The other vehicle behavior prediction device 15 predicts the behavior of the other vehicle OV from the time point shown in FIG. 4A onwards to enable the host vehicle 1 to travel safely without a collision between the host vehicle 1 and the other vehicle OV.

Specifically, in the example shown in FIG. 4A, the sensor information acquisition unit 3C acquires information representing that a surrounding situation sensor for detecting the surrounding situation of the other vehicle OV (more specifically, a surrounding situation sensor (for example, a rear radar, a rear camera, etc.) which can detect the surrounding vehicle SV) is not included in the other vehicle OV.

The other vehicle behavior prediction unit 3F predicts behavior of the other vehicle OV based on information representing that a surrounding situation sensor (more specifically, a surrounding situation sensor which can detect the surrounding vehicle SV) for detecting the surrounding situation of the other vehicle OV is not included in the other vehicle OV acquired by the sensor information acquisition unit 3C, time series detection results DRO of the other vehicle OV by the surrounding situation sensor 11 (more specifically, the trajectory of the position of the other vehicle OV from the time the other vehicle OV passes the position P1 to the time the other vehicle OV passes the position P2), and time series detection results DRS of the surrounding vehicle SV by the surrounding situation sensor 11.

In detail, the other vehicle behavior prediction unit 3F predicts that the possibility of the other vehicle OV accelerating is 20%, predicts that the possibility of the other vehicle OV continuing to travel at a constant speed without accelerating or decelerating is 60%, and predicts that the possibility of the other vehicle OV decelerating is 20%.

In the example shown in FIG. 4B, the host vehicle 1 is traveling in the lane L2, the other vehicle OV is traveling in front of the host vehicle 1, and the surrounding vehicle SV is passing on the left side (the left side of FIG. 4B) of the other vehicle OV and attempting to overtake the other vehicle OV. More specifically, the other vehicle OV is passing through the position P2 of the lane L2. The other vehicle behavior prediction device 15 predicts behavior of the other vehicle OV from the time point shown in FIG. 4B onwards to enable the host vehicle 1 to travel safely without a collision between the host vehicle 1 and the other vehicle OV.

Specifically, in the example shown in FIG. 4B, the sensor information acquisition unit 3C acquires information representing that a surrounding situation sensor for detecting the surrounding situation of the other vehicle OV (more specifically, a surrounding situation sensor (for example, a rear radar, a rear camera, etc.) which can detect the surrounding vehicle SV) is included in the other vehicle OV.

The other vehicle behavior prediction unit 3F predicts the behavior of the other vehicle OV based on information representing that a surrounding situation sensor (more specifically, a surrounding situation sensor which can detect surrounding vehicle SV) for detecting the surrounding situation of the other vehicle OV is included in the other vehicle OV acquired by the sensor information acquisition unit 3C, time series detection results DRO of the other vehicle OV by the surrounding situation sensor 11 (more specifically, the trajectory of the position of the other vehicle OV from the time the other vehicle OV passes the position P1 to the time the other vehicle OV passes the position P2), and time series detection results DRS of the surrounding vehicle SV by the surrounding situation sensor 11.

In detail, the other vehicle behavior prediction unit 3F predicts that the possibility that the other vehicle OV will accelerate is 20%, predicts that the possibility that the other vehicle OV will continue to travel at a constant speed without accelerating or decelerating is 20%, and predicts that the possibility that the other vehicle OV will decelerate (i.e., will allow the surrounding vehicle SV to overtake the other vehicle OV) is 60%.

### Third Embodiment

A host vehicle 1 to which the other vehicle behavior prediction device 15 of a third embodiment is applied is configured in the same manner as the host vehicle 1 to which the other vehicle behavior prediction device 15 of the first or second embodiment is applied, except for the points described below.

As described above, in the host vehicle 1 to which the other vehicle behavior prediction device 15 of the first embodiment is applied, the vehicle control device 14 has an autonomous driving function for controlling the steering actuator 14A, the braking actuator 14B, and the drive actuator 14C to cause the host vehicle 1 to drive autonomously without the need for operation by the driver of the host vehicle 1. Specifically, the vehicle control device 14 generates a driving plan for the host vehicle 1 to reach its destination based on, for example, map information, position information of the host vehicle 1, information representing the destination of the host vehicle 1, etc. Furthermore, the vehicle control device 14 causes the host vehicle 1 to drive autonomously in accordance with the driving plan. In detail, the vehicle control device 14 causes the host vehicle 1 to drive autonomously while revising the driving plan to avoid collisions between the host vehicle 1 and the other vehicles OV, etc., based on detection results of the surrounding situation sensor 11, prediction results of the behavior of the other vehicles OV (refer to FIG. 2A and FIG. 2B) by the other vehicle behavior prediction device 15, etc.

In contrast, in the host vehicle 1 to which the other vehicle behavior prediction device 15 of the third embodiment is applied, the vehicle control device 14 has a driving assistance function. Specifically, when it is predicted that it will be necessary to avoid a collision between the host vehicle 1 and the other vehicle OV (refer to FIG. 2A and FIG. 2B) based on the detection results of the surrounding situation sensor 11 and the prediction results of the behavior of the other vehicle OV by the other vehicle behavior prediction device 15, the vehicle control device 14 causes the HMI 13 to output an alert indicating as such.

Though the embodiments of the other vehicle behavior prediction device, other vehicle behavior prediction method, and non-transitory recording medium of the present disclosure have been described with reference to the drawings as described above, the other vehicle behavior prediction device, other vehicle behavior prediction method, and non-transitory recording medium of the present disclosure are not limited to the embodiments described above, and appropriate modifications can be made without departing from the spirit of the present disclosure. The configurations of the examples of the embodiments described above may be appropriately combined. Though the process performed by the other vehicle behavior prediction device 15 in each of the examples of the embodiments described above has been described as software process performed by executing a program, the process performed by the other vehicle behavior prediction device 15 may also be the process performed by hardware. Alternatively, the process performed by the other vehicle behavior prediction device 15 may also be the process which combines both software and hardware. Furthermore, the program stored in the memory 152 of the other vehicle behavior prediction device 15 (the program for realizing the function of the processor 153 of the other vehicle behavior prediction device 15) may be recorded, provided, distributed, etc., on a computer-readable storage medium (non-transitory recording medium) such as a semiconductor memory, a magnetic recording medium, an optical recording medium, etc.

What is claimed is:

1. An other vehicle behavior prediction device comprising a processor configured to:
predict behavior of an other vehicle travelling in surroundings of a host vehicle; and
acquire information representing whether a surrounding situation sensor for detecting a surrounding situation of the other vehicle is included in the other vehicle or information representing a configuration of the surrounding situation sensor included in the other vehicle,
wherein the processor is configured to predict behavior of the other vehicle based on information representing whether the surrounding situation sensor is included in the other vehicle or information representing a configuration of the surrounding situation sensor included in the other vehicle.

2. The other vehicle behavior prediction device according to claim 1, wherein behavior of the other vehicle predicted when information representing that the surrounding situation sensor is not included in the other vehicle is acquired and behavior of the other vehicle predicted when information representing that the surrounding situation sensor is included in the other vehicle is acquired are different.

3. The other vehicle behavior prediction device according to claim 1, wherein the processor is configured to:
acquire information representing whether a surrounding vehicle traveling in surroundings of the other vehicle is present; and
predict a possibility of a lane change of the other vehicle based on information representing whether the surrounding situation sensor is included in the other vehicle or information representing a configuration of the surrounding situation sensor included in the other vehicle, and information representing whether the surrounding vehicle is present, by using a prediction model obtained by performing learning using teacher data, which is a data set of information representing whether a learning surrounding situation sensor for detecting a surrounding situation of a learning other vehicle is included in the learning other vehicle or information representing a configuration of the learning surrounding situation sensor included in the learning other vehicle and information representing whether a learning surrounding vehicle traveling in surroundings of the learning other vehicle is present, and labels representing information on whether the learning other vehicle changed lanes.

4. The other vehicle behavior prediction device according to claim 1, wherein the processor is configured to:
generate information representing whether the surrounding situation sensor is included in the other vehicle or information representing a configuration of the surrounding situation sensor included in the other vehicle based on an image including the other vehicle captured by a camera mounted on the host vehicle; and
acquire information representing whether the surrounding situation sensor is included in the other vehicle or information representing a configuration of the surrounding situation sensor included in the other vehicle.

5. The other vehicle behavior prediction device according to claim 1, wherein the processor is configured to acquire information representing whether the surrounding situation sensor is included in the other vehicle or information representing a configuration of the surrounding situation sensor included in the other vehicle obtained by communication between the host vehicle and outside of the host vehicle.

6. The other vehicle behavior prediction device according to claim 1, wherein the processor is configured to:
generate information representing whether the surrounding situation sensor is included in the other vehicle or information representing a configuration of the surrounding situation sensor included in the other vehicle based on radio waves which are transmitted from the surrounding situation sensor and detected by a radar detector mounted on the host vehicle; and
acquire information representing whether the surrounding situation sensor is included in the other vehicle or information representing a configuration of the surrounding situation sensor included in the other vehicle.

7. An other vehicle behavior prediction method comprising:
predicting behavior of an other vehicle travelling in surroundings of a host vehicle; and
acquiring information representing whether a surrounding situation sensor for detecting a surrounding situation of the other vehicle is included in the other vehicle or information representing a configuration of the surrounding situation sensor included in the other vehicle,
wherein behavior of the other vehicle is predicted based on information representing whether the surrounding situation sensor is included in the other vehicle or information representing a configuration of the surrounding situation sensor included in the other vehicle.

8. A non-transitory recording medium having recorded thereon a computer program for causing a processor to perform a process comprising:
predicting behavior of an other vehicle travelling in surroundings of a host vehicle; and
acquiring information representing whether a surrounding situation sensor for detecting a surrounding situation of the other vehicle is included in the other vehicle or information representing a configuration of the surrounding situation sensor included in the other vehicle,
wherein behavior of the other vehicle is predicted based on information representing whether the surrounding situation sensor is included in the other vehicle or information representing a configuration of the surrounding situation sensor included in the other vehicle.
